(19) United States
(12) Patent Application Publication
(10) Pub. No.: US 2025/0196167 A1
(43) Pub. Date: Jun. 19, 2025

(54) HIGH-PRESSURE LIQUID ROTARY NOZZLE WITH FLUID BRAKE MECHANISM

(71) Applicant: STONEAGE, INC., Durango, CO (US)

(72) Inventor: Joseph A. SCHNEIDER, Durango, CO (US)

(21) Appl. No.: 18/980,590

(22) Filed: Dec. 13, 2024

Related U.S. Application Data
(60) Provisional application No. 63/610,309, filed on Dec. 14, 2023.

(51) Int. Cl. B05B 3/04

(52) U.S. Cl. CPC B05B 3/04

(57) ABSTRACT

A high-pressure liquid nozzle housing encloses a self-rotating speed-controlled nozzle. The nozzle assembly structure comprises a generally cylindrical housing body forming a relatively stationary reference structure with respect to a coaxial rotatable nozzle carrying tubular shaft member contained therein. The tubular shaft member is a rotary structure having an input end in sealed relationship with a connecting high pressure liquid input member. A fluid speed brake mechanism for the spray nozzle is contained in a sealed chamber and comprises an impeller, a stator tube device and a turbine device. Rotation of the tubular nozzle shaft causes the impeller device to accelerate the flow of fluid through the stator tube device and into the turbine device, which imparts a countervailing rotational force to the rotational force generated by the sprayer head nozzle assembly attached to the end of the tubular nozzle shaft. The reduced rotational speed significantly reduces wear and heat generation at the moving parts within the nozzle assembly, and increases the effectiveness of the nozzle by increasing the dwell time of the cleaning fluid.

### CROSS-REFERENCE TO RELATED APPLICATION

This application claims the benefit of U.S. Provisional Application No. 63/610,309, filed on Dec. 14, 2023, entitled “High Pressure Liquid Rotary Nozzle With Fluid Brake Mechanism,” the technical disclosures of which is hereby incorporated by reference in its entirety.

### TECHNICAL FIELD

This invention relates to a rotary nozzle assembly for spraying high pressure liquids and having a fluid braking device driven by the rotary nozzle to act as a rotary fluid speed brake to prevent undesirable overspeed of nozzle rotation.

### BACKGROUND OF THE INVENTION

In the field of high pressure rotary liquid handling devices, where the operating parameters can exceed 44,000 psi, rotating speeds of 8,000 rpm and flow rates of 25 gpm, operating parameters relating to construction, cost, durability and ease of maintenance of rotating nozzles present many problems. High pressure water jet cleaning devices utilizing reaction force rotary nozzles tend to rotate at very high speeds. In many applications, such as surface preparation or cleaning operations it is desirable to slow down such rotary nozzle speed to maximize usable lifetime of the rotary nozzle and to effectively improve the cleaning efficiency of such nozzles. A speed reducing device fastened to the rotating shaft of such rotary nozzles is often utilized to retard rotation of the nozzle. Combined length and diameter of such nozzles may not exceed a few inches. The more extreme operating parameters and great reduction in size compound the problems. Pressure, temperature and wear factors affect durability, ease of maintenance and attendant cost, and inconvenience and safety in use of such nozzle devices. Simple durable low cost and easily maintained speed controlled nozzles are most desirable.

### SUMMARY OF THE INVENTION

Among the objects of the invention is to help achieve a durable light weight elongated rotating high pressure spray nozzle assembly which can be conveniently carried on the end of a spray lance and used to prepare and/or clean a surface or irregularly shaped objects.

Another object of the invention is to provide a durable rotation speed retarding mechanism for the rotating spray head in an elongated small diameter high pressure water spray assembly.

Another object of the invention is to provide an improved speed retarding mechanism for a rotating nozzle member of a small diameter high pressure spray nozzle assembly using a mechanism incorporating a centrifugal impeller driven by the rotary nozzle, which in turn drives a speed retarding turbine device.

Another object of the invention is to provide an improved speed retarding mechanism for a rotating nozzle member of a small diameter high pressure spray nozzle assembly using increasing flow of internal lubricant through the centrifugal impeller and turbine to create a nozzle braking or retarding effect.

Another object of the invention is to provide in a single isolated sealed chamber of a small diameter high pressure spray nozzle assembly an improved speed retarding mechanism for a rotating nozzle member and a rotating nozzle bearing assembly.

A further object of the invention is to provide an improved rotatable nozzle assembly wherein removal of all principal parts of rotary nozzle support bearings and rotary nozzle speed control mechanisms from a common sealed chamber therefor is achieved through one end of a housing body containing a rotatable nozzle.

Another object of the invention is to provide improved means for replenishing or replacing lubricating liquid of stable viscosity into a sealed chamber enclosing a speed retarding mechanism by merely temporarily removing a plug for a fill opening into the chamber and pumping new liquid into the chamber.

Another object of the invention is to achieve a significant amount of retarding force on a rotary nozzle of a spray nozzle assembly by viscous shear in a speed control mechanism having friction generating speed retarding parts immersed in the viscous liquid.

An example of a device in which the fluidic brake described herein may be used is referred to within the industry as a “shotgun” tool. However, the fluidic brake described herein may be used in any hydraulic rotary tool wherein it is desirable to slow the rotation that would otherwise occur without a mechanical brake.

The high pressure of this invention is intended for use in a High Pressure (HP) range of approximately 2,000 to 44,000 psi. Thus the seal between a relatively stationary seal holder and the rotating inlet end of a rotary nozzle tube must contain any selected pressure to be used. For a selected pressure, the flow rate and the offset of the nozzle discharge tips provide the reactive force to rotate the nozzle. With a nozzle speed control means utilizing interrelated friction generating speed retarding mechanisms immersed in a high temperature resistant lubricating liquid, such as automatic transmission fluid, confined in a sealed protected speed control chamber to prevent overspeeding, the speed can be kept in the range of about 500 to 8000 rpm (with an optimal target of approximately 2,000 rpm) for a spraying operation. Without practical maximum speed control a runaway rotary nozzle can reach several thousand rpm which can detrimentally affect the spraying function and also rapidly increase wear of seals, bearings and other operating parts of the rotary nozzle structure.

In one embodiment, radial ball bearings form axially spaced load distributing bearing means between a rotating tubular nozzle shaft and an inner cylindrical surface of a nozzle housing body. The bearings rotatably support the shaft coaxially within the housing body, and prevent axial movement of the shaft when the shaft is subject to high forwardly directed thrust forces from internal high liquid pressures at rotary seal members in the nozzle assembly.

In one embodiment, the nozzle assembly structure comprises a generally cylindrical housing body forming a relatively stationary reference structure with respect to a coaxial rotatable nozzle carrying tubular shaft member contained therein. The tubular shaft member is a rotary structure having an input end in sealed relationship with a connecting high pressure liquid input member in the input end of the housing, which has an internally threaded portion for receiving the male threaded end, i.e., cone- and thread or conventional pipe threads, of a nozzle structure supporting lance or other means (not shown) for supplying the high pressure spray liquid to the nozzle assembly structure.

In one embodiment, between the liquid input member and the input end of the nozzle shaft is a high pressure sealing assembly forming a passage for confining high pressure liquid being transferred to the nozzle and comprising a stationary annular seal holder opposite to the end of the shaft for supporting annular seal components arranged end-to-end and having inner diameters corresponding to the inner diameter of the input end of the shaft. The seal holder is counterbored to provide a stepped annular recess with a smooth cylindrical wall coaxial with the shaft and containing the end-to-end components comprising a plastic annular cylindrical seal member and an annular cylindrical carbide wear resistant hard sealing ring seat which is held between the plastic seal and the end of the shaft when high pressure liquid flows through the nozzle during its spraying operation. The carbide seat is kept coaxial with the shaft by the stepped recess and its forward end projects beyond the recess into sealing engagement with the end of the shaft. The outside wall of the plastic seal fits snugly against the wall of the stepped recess and has an additional softer sealing O-ring seal in a longitudinally central annular groove between the plastic seal and the wall of the stepped recess to provide additional sealing means therebetween and hold the plastic seal in position against rotation and against the carbide seat as the latter is held against the shaft by pressure of the spray liquid on the plastic seal and rotates with the shaft during operation of the nozzle. As the end of the plastic seal wears where it contacts the carbide seat, liquid pressure on the plastic seal will push it forwardly along the stepped recess to assure continuity of the sealing assembly at the input end of the shaft.

The sealing assembly contains the high working pressure of the high pressure spray liquid and prevents escape of high pressure liquid from the intended liquid flow path passage into the inlet end of the tubular nozzle member. In one embodiment, the seal member is made of an extrusion-resistant cross-linked ultra-high molecular weight polyethylene. The additional softer sealing O-ring is preferably of resilient tough heat-resistant elastomeric material held in a groove of rectangular cross section machined in the outer cylindrical surface of the seal member midway along its length, but other materials or seals could be used. When the end of the seal member-engaging the inlet end of the seat wears down to near the O-ring groove, the plastic seal member can be removed and reversed and used until the other end of the seal member becomes similarly worn. The seal assembly used permits easy replacement of a single plastic seal member with O-ring when it is worn at a small fraction of the cost of replacement of the carbide seat. The carbide seat is pressed axially against and rotates with the nozzle shaft during operation of the spray nozzle apparatus.

In one embodiment, the sealing assembly comprises the seal holder, the plastic seal and the carbide seat. This provides a very effective seal at low cost because of the simplicity of configuration of these three principal parts and their manner of retention, and replacement when necessary after wear, during the life of the nozzle structure. Wear of 50% of the plastic seal is tolerated without degradation of sealing by this assembly.

A rotational speed brake mechanism of the nozzle assembly is contained in a sealed chamber which encloses ball bearing means for rotatably supporting the rotatable tubular nozzle shaft member which carries the spray liquid to the nozzle spray head. This chamber is sealed to protect the bearings and speed braking mechanism and lubricants therefor from any spray liquid which might escape from the spray liquid passages within the nozzle housing. The nozzle spray head comprises a plurality of canted discharge bores which cause the nozzle spray head as well as the tubular nozzle shaft member to rotate with respect to the body of the nozzle assembly.

The fluid speed brake mechanism comprises an impeller device attached to the rotatable tubular nozzle shaft. Rotation of the tubular nozzle shaft causes the impeller device to accelerate the flow of fluid through the fluid speed brake mechanism.

In a preferred embodiment, the impeller device comprises a centrifugal impeller. The impeller device is enclosed or shrouded by a stator tube device, which channels the flow of the fluid in the sealed speed control chamber as it exits the centrifugal impeller device and directs the accelerated flow through a plurality of channels formed between an interior and exterior wall of the stator tube device. While the stator tube is coaxially aligned with the rotatable tubular nozzle shaft and the impeller device, the stator tube device is fixed to the nozzle housing body. The stator tube device includes a central coaxial aperture through which the tubular nozzle shaft and the impeller device are configured to freely rotate. Each of the channels formed between the interior and exterior wall of the stator tube device directs the fluid propelled by the impeller device to one of a plurality of exit jets configured on the exit end of the stator tube device. The exit jets are positioned so as to eject the accelerated fluid into a turbine device attached to the tubular nozzle shaft. The turbine device comprises cylindrical body coaxially aligned with the tubular nozzle shaft and having a plurality of turbine blades or vanes formed therein which extracts energy out of the accelerated fluid and redirects it back through the central aperture of the stator tube device and into the impeller device. The fluid impinging on the plurality of turbine blades or vanes imparts a countervailing torque onto the tubular nozzle shaft acting as a fluid speed brake on the tubular nozzle shaft. The cross section of the individual turbine blade or vanes are configured to produce a countervailing rotational force to the rotational force generated by the sprayer head nozzle assembly attached to the end of the tubular nozzle shaft.

The sealed bearing-enclosing and speed brake chamber is closed at the forward end of the housing by a removable front cap member and an annular forward end lip seal between the outer surface of the shaft and an inner surface of the cap member. The rear end of the sealed chamber is sealed by an annular lip seal between the tubular shaft and a necked portion of the housing. A removable threaded port plug in an opening in the housing body allows lubricating liquid to be injected under pressure into the sealed chamber. The lips of the seals are so arranged that the forward seal blocks escape of the liquid but the rear seal allows liquid to escape past its lip and thus allow replenishment or complete replacement of the liquid by merely removing the plug. Alternatively, the sealed chamber may further include additional threaded ports that allow the lubricating fluid to be flushed through the sealed chamber.

The various internal elements in the sealed bearing chamber of the nozzle assembly, including the bearings, are kept in relatively fixed axial positions by means including the removable front cap member, which, when properly seated, pushes all such elements toward one end of the housing where an element of the assembly abuts an inwardly extending housing shoulder.

The fluid speed brake mechanism described herein is useful in governing the spray pattern from the spray head as the nozzle assembly is moved by its support relative to an object or surface being sprayed. Also, the reduced rotational speed significantly reduces wear and heat generation at the moving parts within the nozzle assembly. The fluidic speed brake is described herein in the context of a high pressure hydraulic rotary tool commonly referred to as a “shotgun” tool. However, the fluid speed brake mechanism can be used in any fluidic, high pressure rotary tool.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a frontal perspective view of an embodiment of the high-pressure liquid spray nozzle assembly of the present device;

FIG. 2a is an exploded view thereof;

FIG. 2b is an exploded side view thereof;

FIG. 3a is a longitudinal cross-sectional view of the high-pressure liquid spray nozzle assembly shown in FIG. 1;

FIG. 3b is a longitudinal cross-sectional view of the nozzle housing body of the high-pressure liquid spray nozzle assembly shown in FIG. 1 depicting the inner bore of the nozzle housing body;

FIGS. 4a and 4b are longitudinal cross-sectional views of the sprayer head nozzle assembly of the nozzle housing body of the high-pressure liquid spray nozzle assembly shown in FIG. 1;

FIG. 5a is a rear perspective view of the impeller of the high-pressure liquid spray nozzle assembly shown in FIG. 1;

FIG. 5b is a front perspective view thereof;

FIG. 5c top plan view thereof;

FIG. 6a is a rear perspective view of the stator tube of the high-pressure liquid spray nozzle assembly shown in FIG. 1;

FIG. 6b is a front perspective view thereof;

FIG. 6c is a plan view of the entrance or inlet thereof;

FIG. 6d is a plan view of the exit or outlet thereof;

FIG. 7a is a rear perspective view of the turbine device of the high-pressure liquid spray nozzle assembly shown in FIG. 1;

FIG. 7b is a front perspective view thereof;

FIG. 7c is a plan view of the entrance or inlet thereof; and

FIG. 7d is cross-sectional view plan view of the entrance or inlet thereof.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

### DETAILED DESCRIPTION OF THE INVENTION

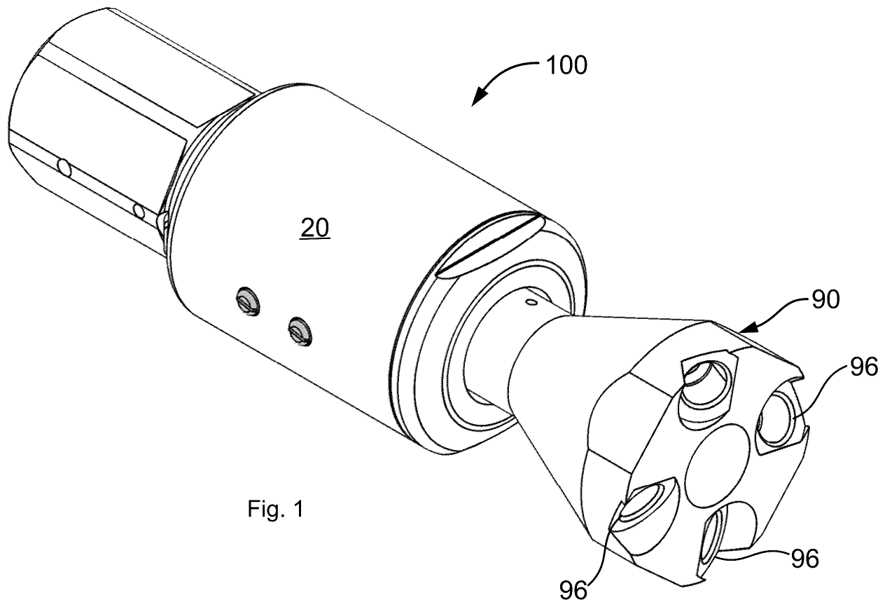

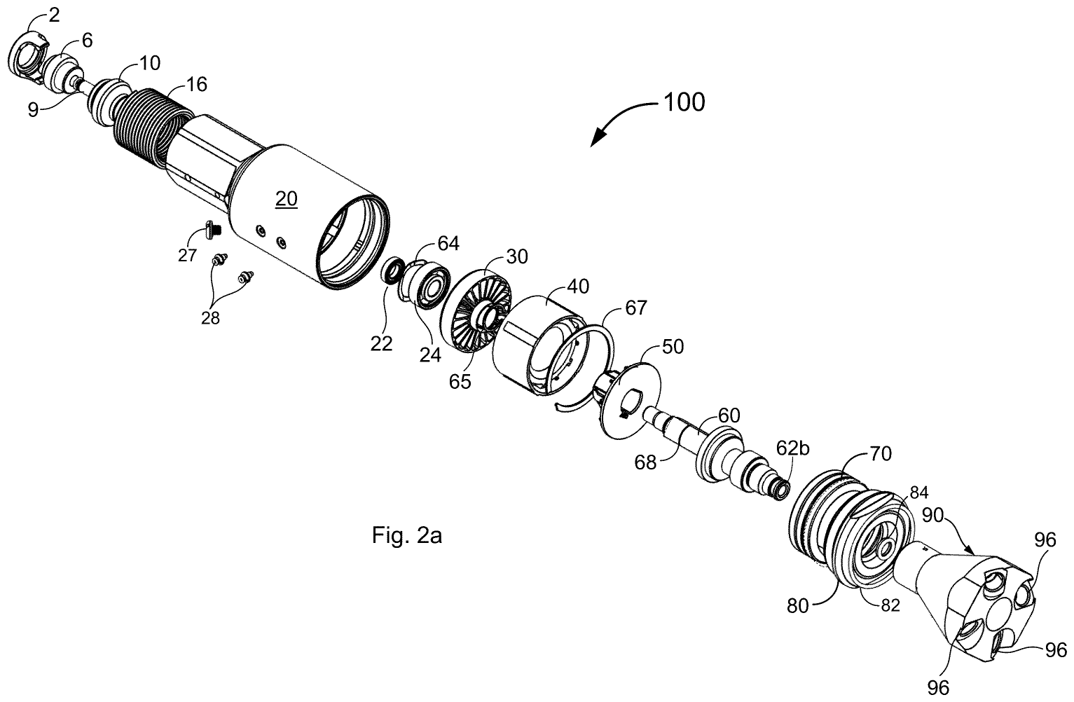

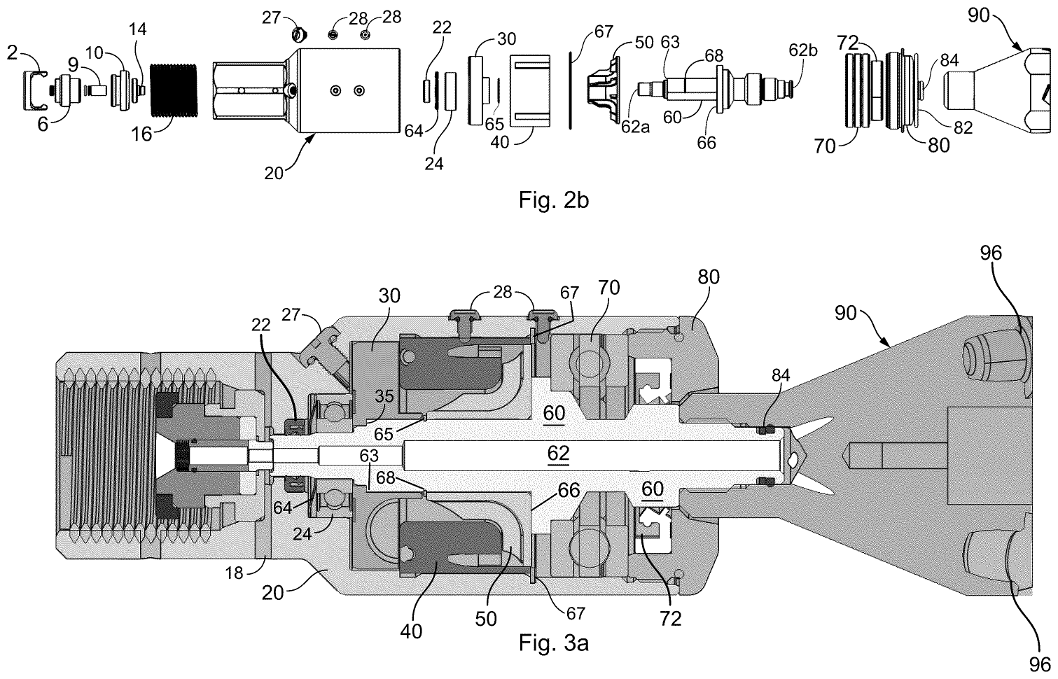

FIGS. 1-3b show a high-pressure liquid nozzle apparatus 100 assembly having an elongated cylindrical nozzle housing body 20 within which is rotatably mounted a coaxial hollow or tubular nozzle shaft 60 attached to a nozzle head 90 having a plurality of canted discharge bores 96, which are fluidly connected to the coaxial passageway 62 of the tubular nozzle shaft 60. The coaxial passageway 62 of the tubular nozzle shaft 60 carries high pressure liquid to the canted discharge bores 96 of the discharge spray head 90 at one end of the body 20. The nozzle head 90 on the forward end of the rotating nozzle shaft 60 provides multiple jet streams of the liquid for cleaning purposes with the canted streams oriented to provide a jet reaction torque on the nozzle shaft 60 to make it self-rotating. For shaft retarding purposes pointed out hereinafter the direction of self rotation in this illustrated embodiment is clockwise when looking into the discharge end of the nozzle assembly.

High pressure liquid is supplied to the inlet end of the shaft 62a by inlet means comprising a necked down inlet end of the housing body 20, which may be internally threaded with a helicoil 16 when the housing body 20 is constructed of aluminum, to connect to a conventional cone-and-thread threaded connector on the end of a rigid lance or pipe forming the source of high pressure liquid (not shown) for the nozzle assembly. In another embodiment, the inside of the inlet end of the body 20 has a threaded cylindrical bore 16A which ends at an inwardly directed shoulder 10A providing an annular sealing surface against which a seal holder cartridge comprising snap fit housing 2, inlet seat housing 6, high pressure (HP) seal assembly 9, retaining housing 10 and carbide seat 14 is clamped by the connector of the liquid supply source. The seal holder cartridge has a cylindrical outer surface which is slidable within the bore in the inlet end of body 20. The inlet seat housing 6 has a conical high pressure liquid entrance forwardly tapering to a short reduced diameter cylindrical orifice. Just forward of the orifice is a stepped smooth annular cylindrical counterbored seal supporting surface completely enclosing an axially slidable HP seal assembly 9 which abuts a hard durable carbide annular retaining housing seal member or seat 14, which is partially contained in the retaining housing 10 counterbore.

When the conventional cone-and-thread connector on the high pressure liquid source (not shown) is secured in the entrance end of housing body 20 it forms a sealed connection at the conical entrance to the seal holder cartridge and clamps the seal holder cartridge tightly in place against the shoulder at the end of the bore in the inlet end of housing body 20. The stepped coaxial counterbored passage of the seal holder cartridge presents a smooth inner cylindrical surface within which are coaxially supported in end-to-end relationship the annular cylindrical deformable HP seal assembly 9 and the annular cylindrical rigid carbide seat 14 of the retaining housing 10 which are pushed forward solely by high liquid pressure on the HP seal assembly 9 and on the retaining housing 10 to force the seat against the inlet end of the tubular shaft 62a. The sealing seat member of the retaining housing 10 has a first end face beveled at its outer edge and abutting the tubular nozzle shaft 60 with an area of contact smaller than an area where its opposite end face abuts the inlet seat housing 6 whereby the force differential across the seat of the retaining housing 10 due to the high pressure liquid in said inlet passage holds the seat 18 of the retaining housing 10 against the tubular shaft inlet 62a during operation of the apparatus. The HP seal assembly 9 is made of hard strong wear resistant deformable extrusion-resistant material such as a high strength plastic.

Upon removal of the cone-and-thread connection on the high pressure liquid source from the inlet end of the housing body 20, the seal holder cartridge comprising snap fit housing 2, inlet seat housing 6, HP seal assembly 9, retaining housing 10 and carbide seat 14 is free to be withdrawn from the inlet end of the housing body 20 for inspection, repair or replacement, without interfering with or disassembling any other part of the nozzle apparatus.

The seal holder cartridge comprising snap fit housing 2, inlet seat housing 6, HP seal assembly 9 retaining housing 10 and carbide seat 14 form a high pressure liquid sealing means within said housing body 20 for confining high pressure liquid flow between the inlet end connection to the housing body 20 and the inlet end of the tubular shaft member 62a to a flow passage 62 within said housing body 20 which is isolated from the interior of a sealed chamber between the tubular shaft structure 60 and the housing body 20. Any leakage of high pressure liquid to the outside of the seal holder cartridge can escape through the slotted weep passages 18 in the body 20 to the outside of the nozzle assembly. The inlet end 62a of the tubular shaft 60 has a reduced diameter portion extending rearwardly through a small aperture in a transverse wall in the body 20 and into the chamber bled by the weep holes 18 where the seat 14 seals against the inlet end 62a of the shaft 60.

The nozzle housing body 20 includes an inner bore cylindrical surface containing a sealed chamber wherein the speed brake mechanism is configured. The sealed bearing-enclosing and speed brake chamber is closed at the forward end of the housing body 20 by a removable front cap member 80 and an annular rearward end lip seal 72 between the outer surface of the shaft 60 and an inner surface of the cap member 80. The sealed chamber contains radial ball bearings 24 and axial ball bearings or angular contact bearings or radial ball bearings 70 for rotatably supporting the tubular shaft structure 60, a fluid speed brake mechanism described in detail hereinafter and lubricating means. Ends of the sealed chamber are defined just beyond the bearings 24 and 70 by means of a front shaft seal 72 between the thrust bearing 70 and front cap 80 and a rear shaft seal 22 between the rear shaft bearing 24 and an inner stepped surface 22A of the housing body 20.

The lip seals 22 and 72 at opposite ends of the sealed chamber between the rotary shaft and the housing 20 have their sealing lips directed inward of the nozzle apparatus. This enables lubricating liquid to be pumped by any suitable syringe-type device into an opening sealed by the screw plug 27 for replenishment or complete replacement of the lubricating liquid in the chamber which is again sealed after such pumping. Additionally, the lubricating liquid can be flushed through the sealed chamber using the screw plug port 27A and accessory ports 28A. The screw plug 27 is located in the housing body 20 near the rear where the diameter of the housing body 20 necks down to inlet end of the housing body 20. The rear shaft seal 22 is oriented to allow excess lubricating liquid to escape to the area of weep ports or passages 18 in the body 20 which communicate to the outside of the housing body 20 of the nozzle assembly 100. Complete replenishment of deteriorated and contaminated liquid is indicated by the flow of clear clean liquid from the weep ports 18 of the housing 20 as pumping of clean liquid progresses.

The forward end of the tubular shaft structure 60 is rotatably supported by the radial ball bearing thrust bearing 70 and the forward end of nozzle housing body 20 is capped by an annular front cap member 80 screwed into the inner forward end of the housing body 20. The rear end of the tubular shaft structure 60 is rotatably supported by the radial ball bearing 24 between the shaft member 60 and the housing body 20. The axial position of the thrust bearing 70 is fixed by having its outer race pushed by the front cap 80. The axial position of the tubular shaft structure 60 is fixed by the inner race of the thrust bearing 70 being clamped between opposing shoulders on shaft member 60 when screwed together.

It is desirable to insure that the torque produced by the discharged jets from canted discharge bores 96 of the sprayer head nozzle assembly 90 are within the operating limits of the tool. The preferred tool operational torque range is from 4 to 30 in.-lb. and it is generally desirable not to exceed 35 in-lb of torque. The higher figure of 35 in-lb will provide more latitude for tolerable ranges of overall operating parameters.

The jet reaction force and nozzle offset are designed to produce from 4 to 30 in.-lb of torque based on pump size and setup. Too small a torque may result in erratic rotation rates or be insufficient to start rotation. Too large a torque will exceed the ability of the tool to govern rotation speed and may cause heat buildup, temperature rise in the internal parts, rapid seal wear, and excessive rotation speeds affecting the cleaning operation of the jet streams. The tool should not generally be operated at torques above 35 in-lb.

The flow rating of the tool is 0.38 Cv. This means that at 9 gpm the pressure loss through the tool is about 560 psi, while at 12 gpm the loss is about 997 psi.

The outside wall of the HP seal assembly 9 fits snugly against the wall of the counterbored stepped recess in the inlet seat housing 6. An O-ring seal in the longitudinally-central annular groove in the inlet seat housing 6 not only provides additional sealing means between the plastic seal and the wall of the stepped recess but also aides in holding the HP seal assembly 9 in position against rotation as the seal is pushed forward by pressure of the spray liquid on the plastic seal and sealed against the carbide seat 14 as the HP seal assembly 9 is held sealed against and rotates with the input end 62a of the tubular shaft member 60. The seat 14 rotates with the shaft during operation of the nozzle. As the end of the HP seal assembly 9 wears where it contacts the carbide seat 14, liquid pressure on the HP seal assembly 9 will push it forwardly along the counterbored cylindrical recess of the inlet seat housing 6 to assure continuity of the sealing assembly at the input end of the tubular shaft member 60. The importance of the O-ring in the inlet seat housing 6 is to keep high pressure liquid from flowing or leaking around the outside of the HP seal assembly 9.

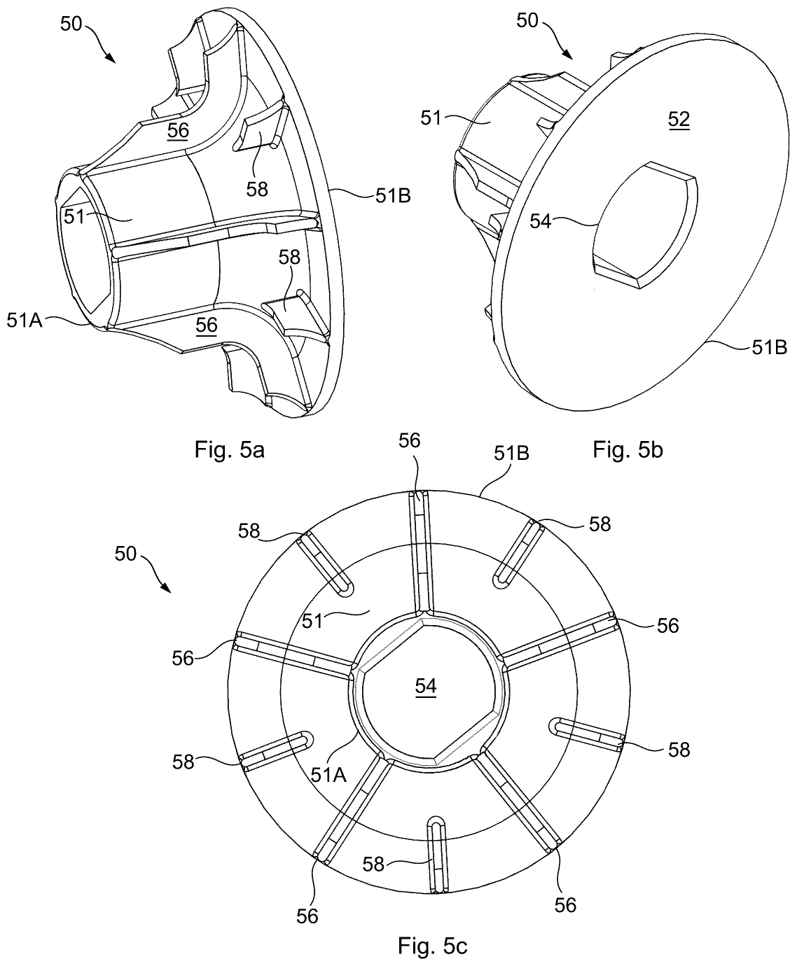

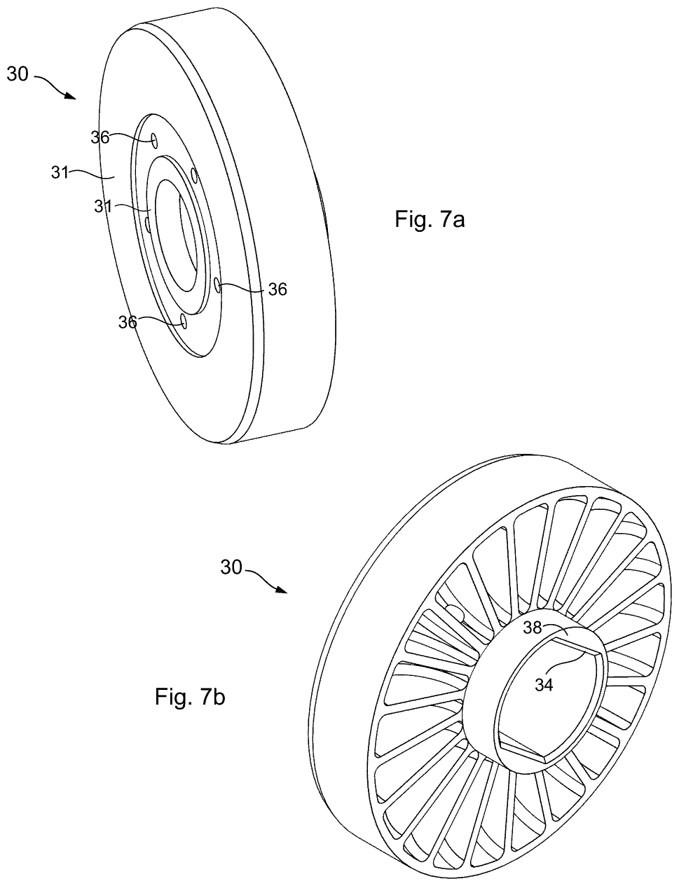

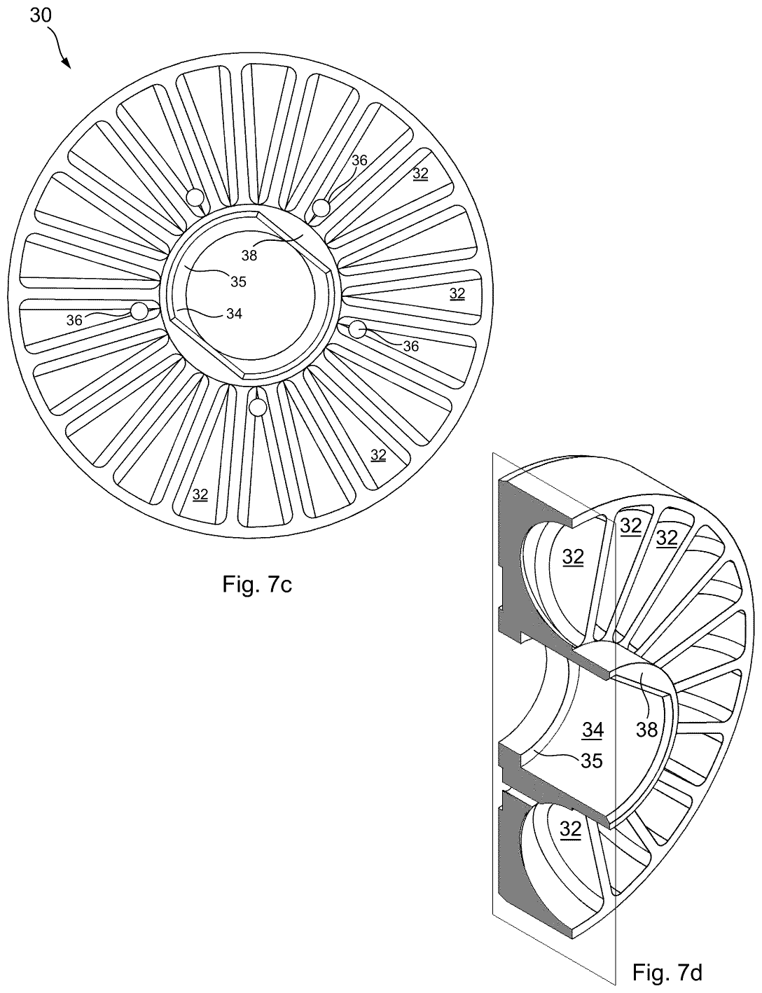

The retarding means for controlling the speed of the self-rotating tubular nozzle shaft structure 60 comprises a fluid speed brake mechanism configured within the sealed chamber of the nozzle housing body 20. The fluid speed brake mechanism comprises an axial-flow centrifugal impeller 50, a stator tube device 40 and a turbine wheel 30, all configured in a coaxial arrangement to the tubular nozzle shaft 60. While the impeller 50 and the turbine wheel 30 are attached to the tubular nozzle shaft 60, the stator tube 40 is attached to the inner cylindrical bore of the nozzle housing body 20. That is, the centrifugal impeller 50 and the turbine wheel 30 both rotate with the tubular nozzle shaft 60, while the stator tube 40 remains stationary with respect to the tubular nozzle shaft 60. When rotated by the tubular nozzle shaft 60, the centrifugal impeller 50 accelerates the flow of the fluid in the sealed chamber. The closed face 52 (sec FIG. 5b) of the impeller 50 is configured adjacent to the main shoulder 66 of the tubular nozzle shaft 60. The axial position of the impeller device 50 relative to the tubular nozzle shaft 60 is secured via a retaining ring 65 configured in a circumferential groove 68 formed in the tubular nozzle shaft 60. When the turbine device 30 is properly configured on the tubular nozzle shaft 60 within the sealed chamber of nozzle housing body 20, the retaining ring 65 is positioned adjacent to but not in contact with the front flange 38 (see FIG. 7b) of the central aperture 34 of the turbine device 30.

The impeller 50 is enclosed or shrouded by the stator tube device 40, which channels the flow of the fluid in the sealed chamber as it exits the centrifugal impeller device 50 and directs the accelerated flow through a plurality of channels 47 formed between an interior 45 and exterior wall 41 of the stator tube device 40. Each of the channels 47 formed between the annular interior 45 and exterior wall 41 of the stator tube device 40 directs the fluid to one of a plurality of exit jets configured on the exit end of the stator tube device.

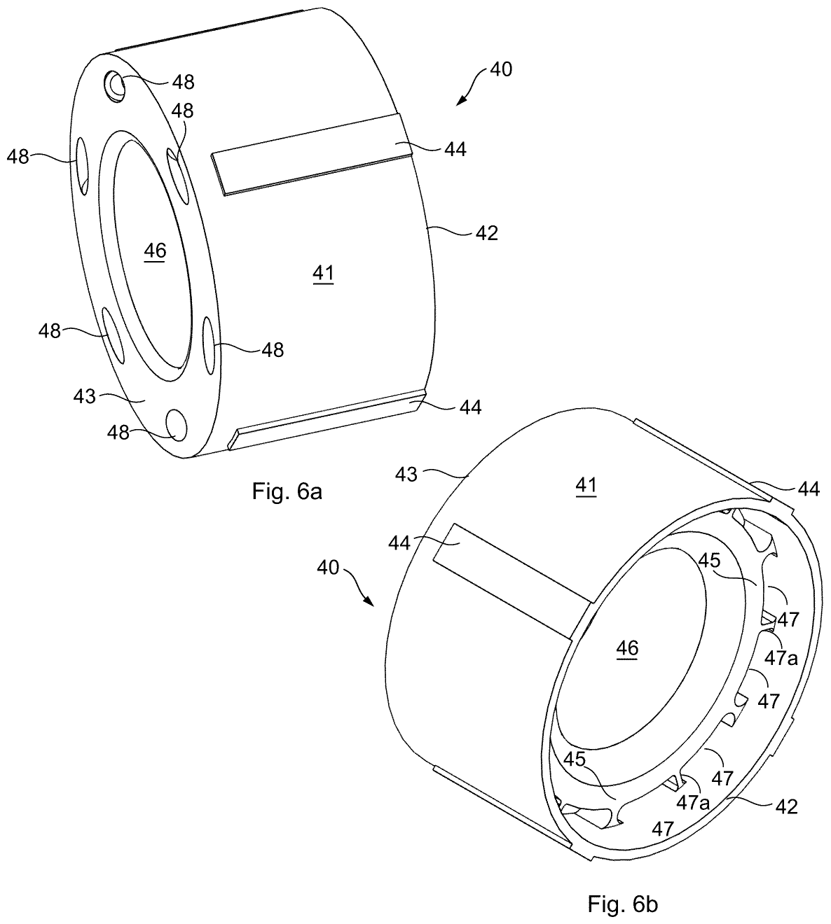

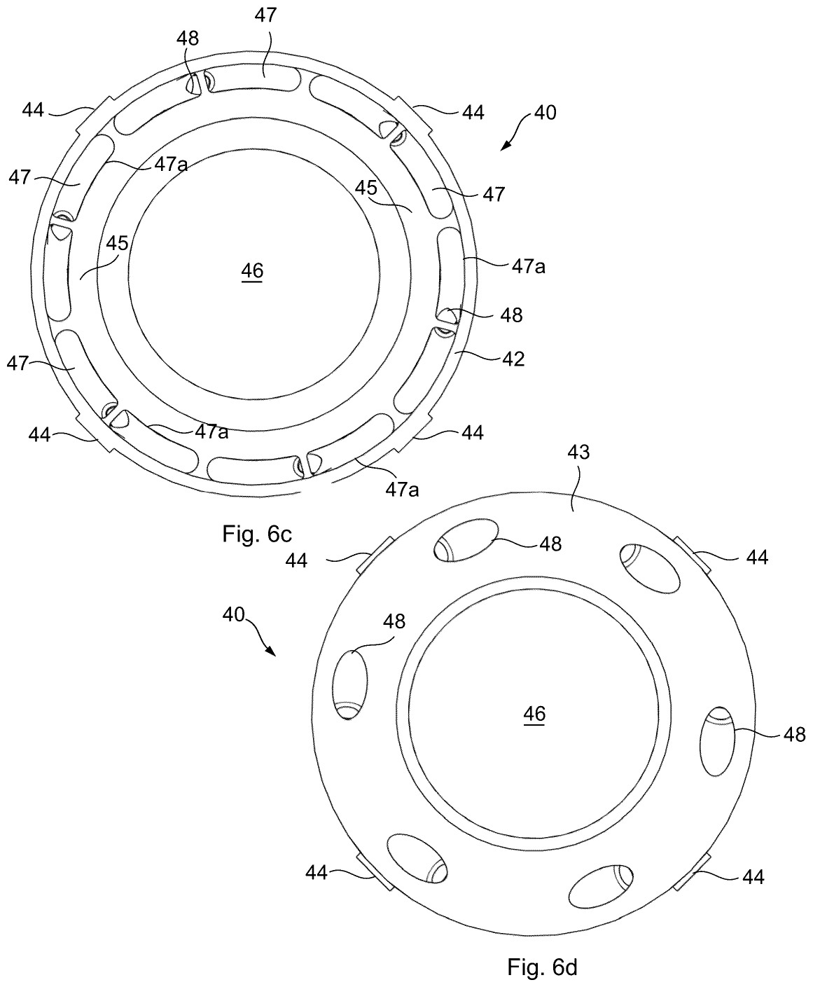

The exit jets 48 (see FIGS. 6a-6b) are positioned so as to eject the accelerated fluid into the turbine wheel device 30 attached to the tubular nozzle shaft 60. The turbine wheel 30 comprises a cylindrical body coaxially aligned with and attached to the tubular nozzle shaft 60, and having a plurality of turbine blades 32 formed therein which extract energy out of the accelerated fluid and redirects it back through the central aperture 46 of the stator tube device 40 and into the impeller device 50. The fluid impinging on the plurality of turbine blades 32 imparts a countervailing torque onto the tubular nozzle shaft 60 acting as a fluid speed brake on the tubular nozzle shaft 60. The cross section of the individual turbine blade 32 is configured to produce a countervailing rotational force to the rotational force generated by the sprayer head nozzle assembly 90 attached to the end of the tubular nozzle shaft 60. The shape of the turbine blades 32 in a particular turbine assembly 30 can be designed to give different speed and torque characteristics depending upon the anticipated circumstances. Nonetheless, in general, the retarding characteristics for the fluid speed brake mechanism of the present invention tend to increase as the rotational speed of sprayer head nozzle assembly 90 increases, leading to a more constant rotational speed over the range of input torque.

With reference now to FIGS. 5a-5c, an embodiment of the centrifugal impeller 50 of the present invention is depicted. The centrifugal impeller 50 has a central aperture 54 whose cross-section locks onto a complementary cross-section of the tubular nozzle shaft 60 so that the centrifugal impeller 50 rotates in unison with the tubular nozzle shaft 60. The longitudinal cross-section of the impeller body 51 curves outward along its length from a first or minimum circumference 51A nearest to the center of rotation to a second or maximum circumference 51B. The impeller 50 includes a plurality of vanes for accelerating the flow of fluid outward from the center of rotation. The vanes may extend down the entire length of the impeller body 51 or only a portion of it. For example, as shown in FIGS. 5a, the vanes comprise a plurality of main vanes 56, which extend along the entire length of the impeller body 51, interspersed with a plurality of secondary or lower vanes 58 that only extend along the lower portion of the impeller body 51 closer to the maximum circumference 51B. Moreover, while the vanes shown in the figures are depicted as being planar and perpendicular to the axis of rotation, it is understood that present invention envisions a wide variety of vane shapes, forms and configurations including curved vanes.

Turning now to FIGS. 6a-6d, an embodiment of the stator tube device 40 of the present invention is depicted. The stator tube 40 comprises an annular structure having two distinct passageways or channels that direct the flow of fluid in the sealed speed control chamber in opposite directions. The annular exterior wall 41 of the stator tube device 40 acts as a shroud to the centrifugal impeller 50 collecting the accelerated outflow of fluid from the maximum circumference 51B portion of the impeller 50 and directing the fluid to a plurality of passageways or channels formed between the annular exterior wall 41 and an annular interior wall 45. The cross-sectional area of the passageway or channels 47 may preferably narrow along the length of the stator tube device 40 such that the exit jets 48 at the outlet 43 of the stator tube device 40 are substantially smaller than the inlets 47a of the passageway or channels 47. The narrowing of the passageway increases the pressure and velocity of the fluid exiting the exit jets 48. In addition, the exit jets 48 may be designed to eject the fluid at an acute angle from the central axis of rotation.

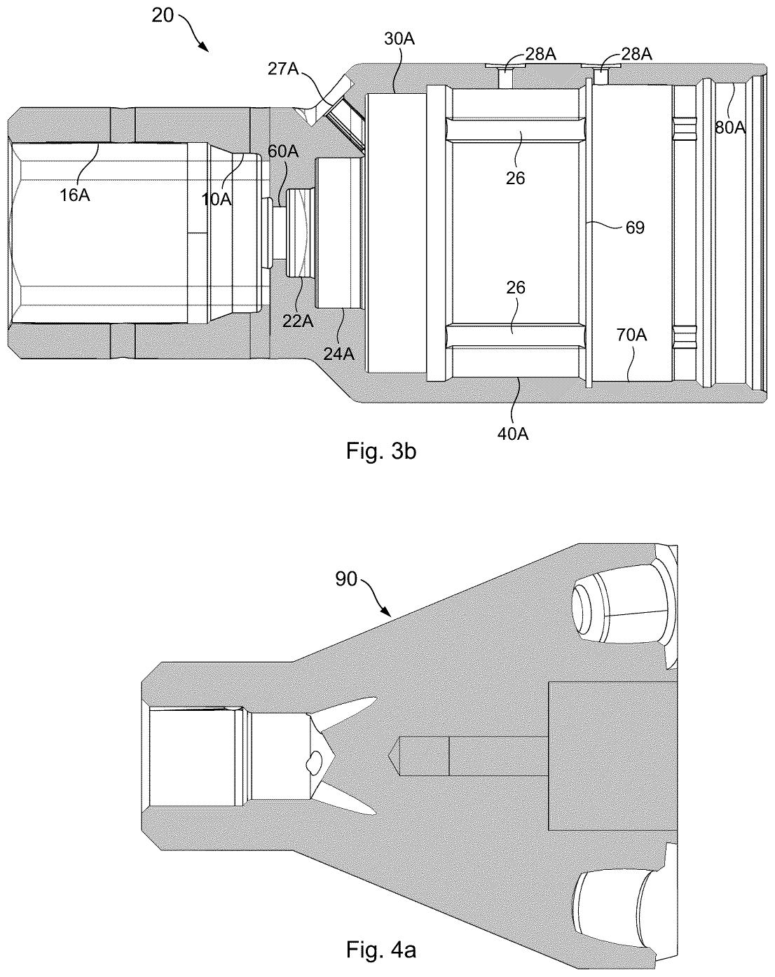

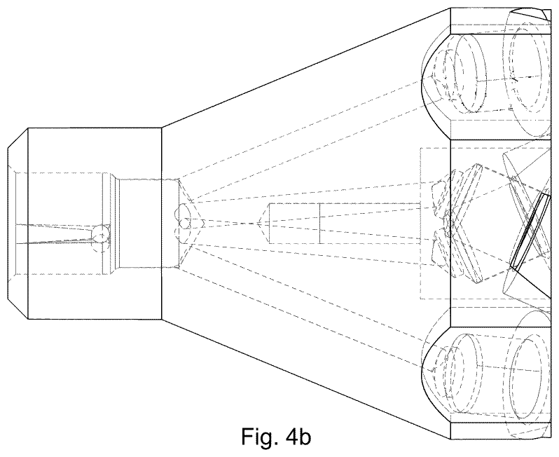

While the stator tube device 40 is coaxially aligned with the rotatable tubular nozzle shaft 60 and the impeller device 50, the stator tube device 40 is fixed to the nozzle housing body 20. In the embodiment depicted in the Figures, the stator tube device 40 includes a plurality of longitudinal ridges 44 designed to engage a similar plurality of complementary longitudinal grooves 26 (see FIG. 3b) formed in the interior surface of the nozzle housing body 20. A retaining ring 67 configured in a circumferential groove 69 formed in the interior surface of the nozzle housing body 20 secures the axial position of the stator tube device 40 within the nozzle housing body 20 to prevent axial movement due to the thrust from the exit jets 48.

The stator tube device 40 includes a central coaxial aperture 46 through which the tubular nozzle shaft 60 and the impeller device 50 are configured to rotate freely. Each of the channels formed between the annular exterior wall 41 and the annular interior wall 45 directs the fluid propelled by the impeller device to one of a plurality of exit jets 48 configured on the exit or outlet end 43 of the stator tube device 40. The exit jets 48 are positioned so as to eject the fluid into a turbine device 30 attached to the tubular nozzle shaft 60.

As shown more particularly in FIGS. 7a-7c, the turbine device 30 comprises a toroid body coaxially aligned with the tubular nozzle shaft 60 and having a plurality of turbine blades or vanes 32 formed therein that extracts energy out of the accelerated fluid and redirects it back through the central aperture 46 of the stator tube device 40 and back into the impeller device 50. The fluid impinging on the plurality of turbine blades or vanes 32 imparts a countervailing torque onto the tubular nozzle shaft 60 acting as a fluid speed brake on the tubular nozzle shaft 60. The cross section of the individual turbine blade or vanes are configured to produce a countervailing rotational force to the rotational force generated by the sprayer head nozzle assembly 90 attached to the end of the tubular nozzle shaft 60.

The turbine device 30 has a central aperture 34 whose cross-section locks onto a complementary cross-section of the tubular nozzle shaft 60 so that the turbine device 30 rotates in unison with the tubular nozzle shaft 60. The turbine device 30 includes a shoulder 35 (see FIGS. 7c-7d) formed within the central aperture 34 that contacts a complementary shoulder 63 formed in the tubular nozzle shaft 60. With reference to FIG. 3a, a portion of rear face 31 of the turbine device 30 is in contact with the shoulder of the shaft bearing 24 axially securing the turbine device 30 in place due to the axial force of the wave spring 64. With reference again to FIGS. 7a-7c, the turbine device 30 may further include vent holes 36, which allow a balance of fluid pressure between the front and rear faces of the turbine device 30 by allowing a portion of the fluid impacting the turbine blades or vanes 32 to flow through the turbine body to the rear face 31 of the turbine device 30 to cushion and lubricate the turbine device 30 against the rear shaft bearing 24 and the void 30A (FIG. 3b) formed in the nozzle housing body 20.

As shown in FIG. 7d, the cross-sectional shape of each turbine blade or vane 32 has a U-shaped profile that channels the fluid flow from the exit jets 48 of the stator tube device 40 from the outer circumference of the turbine device 30 towards the inner diameter of the turbine device, thereby extracting energy out of the accelerated fluid and redirecting it back through the central aperture 46 of the stator tube device 40 and into the impeller device 50.

A suitable lubricating liquid for the bearings and the fluid speed brake mechanism is conventional automatic transmission fluid which is injected into the sealed chamber through an opening 27A in the nozzle housing body 20 which opening is normally sealed to confine the lubricating liquid in the chamber by the screw plug 27. The lubricating liquid for the bearings and the fluid speed brake mechanism is agitated and continually stirred or churned within the sealed chamber. Heat is extracted from the rotating fluid speed brake mechanism and bearings directly by conduction to other engaged parts of the nozzle apparatus and by heat transfer via the lubricating liquid to other parts of the nozzle apparatus including the nozzle housing body 20 and the outer surface of the tubular nozzle member structure 60 through which the high pressure spraying fluid is being forced during spraying operations.

Conventional automatic transmission fluid (ATF) has a viscosity of about 7.24 centistokes at 100° C. and 33.3 centistokes at 40° C., a temperature limit of about 240° F., and a viscosity index exceeding 190. ATF has a high shear stability as compared to conventional motor oils. For synthetic ATF blends the respective viscosities (7.5 and 34 centistokes), temperature limit 270° F. and viscosity index (198) are somewhat higher. For a synthetic ATF the temperature limit may be still higher or about 300° F. It is desirable that the viscosity of the lubricating liquid used with this invention remain stable during continuous use of the nozzle apparatus. Other lubricating fluids may be used such as silicone-based oils and other lubricating liquids with desirable viscosity and thermal characteristics.

It is preferred for optimum tool life with low cost tool materials that a film or layer of the lubricating liquid in which the rotational speed brake mechanism is immersed remains between these immersed parts to avoid a dry friction condition at the proximate surfaces of these parts to provide a significant amount of retardation by viscous shear in the lubricating liquid and to prevent inordinate wear of the relatively moving parts. In cases where continuous operation is desirable this lubricating film is important. However, where short duration or intermittent operation is acceptable, or when environmental conditions dictate, dry friction conditions may be tolerated.

Except as otherwise described, all metallic components of the assemblies of the preferred embodiment herein are preferably made from a strong non-corrosive material such as stainless steel. However, alternative embodiments designed for weight reduction and heat dissipation may comprise a nozzle housing body 20 constructed of aluminum and the impeller device 50, turbine device 30 and stator tube device 40 constructed of 3D printed plastic or metal.

Other variations within the scope of this invention will be apparent from the described embodiments and it is intended that the present descriptions be illustrative of the inventive features encompassed by the appended claims. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I/We claim:

1. A nozzle assembly for spraying high pressure liquid against an object, comprising:
a hollow cylindrical housing having an inner cylindrical bore and a front cap member,
a tubular shaft rotatable coaxially within the housing body and having a liquid input end, said tubular shaft having an output end protruding through said front cap member and including a spray nozzle head connected at said output end for providing rotation to said tubular shaft,
axially spaced bearing mechanisms configured between said tubular shaft and said
inner cylindrical surface of the housing to rotatably support said tubular shaft coaxially within the housing and to prevent axial movement of the tubular shaft when the tubular shaft is subject to high axial forces during spraying,
means defining a sealed chamber between said housing body and said tubular shaft for enclosing said bearing mechanisms and a viscous fluid lubricant,
input means for connecting a high pressure liquid source to an input end of said nozzle assembly in sealed relationship with the input end of the tubular shaft,
a speed brake mechanism, coaxially configured with said tubular shaft within said sealed chamber, for applying a retarding force to the tubular shaft to prevent its rotational speed from exceeding a desired range, wherein said speed brake mechanism comprises
an impeller device connected to said tubular shaft which accelerates the flow of the viscous fluid lubricant in said sealed chamber,
a stator tube device attached to the inner cylindrical bore of the nozzle housing, wherein said stator tube device directs the accelerated output flow from the impeller device to a plurality of exit jets configured on the exit end of the stator tube device, and
a turbine wheel connected to said tubular shaft and having a plurality of turbine blades, said turbine blades being configured to receive the accelerated output flow of the viscous fluid lubricant from the exit jets and redirect the viscous fluid lubricant back through a central aperture of the stator tube device and back into the impeller device; wherein said turbine blades extract energy out of the accelerated viscous fluid lubricant imparting a countervailing torque onto the tubular shaft.

2. The nozzle assembly according to claim 1, said input means including a sealing assembly forming a high pressure liquid sealed passage between the high pressure liquid source and the liquid input end of said tubular shaft.

3. The nozzle assembly according to claim 1, wherein said front cap member is screwed on the housing and has a central opening in sealed relationship with the surface of the tubular shaft to close the sealed chamber at said output end of the nozzle assembly.

4. The nozzle assembly (100) according to claim 1, wherein the impeller device comprises a centrifugal impeller.

5. The nozzle assembly according to claim 1, wherein the stator tube device directs the accelerated output flow from the impeller device to a plurality of exit jets through plurality of channels formed between an interior and exterior wall of the stator tube device.

6. The nozzle assembly according to claim 1, wherein the exit jets eject the viscous fluid lubricant at an acute angle from a central axis of rotation.

7. The nozzle assembly according to claim 1, wherein the turbine device includes vent holes that allow a portion of the viscous fluid lubricant impacting the turbine blades to flow through the turbine body to a rear face of the turbine device to cushion and lubricate the turbine device and bearing mechanisms.

8. The nozzle assembly according to claim 1, wherein each of said turbine blades has a U-shaped profile.

9. The nozzle assembly according to claim 1, wherein the stator tube assembly includes a plurality of longitudinal ridges on its exterior surface and configured to engage a similar plurality of complementary longitudinal grooves formed in the interior surface of the inner cylindrical bore of the nozzle housing body.

10. The nozzle assembly according to claim 1, wherein said stator tube device shrouds the impeller device.

11. The nozzle assembly according to claim 1, wherein said hollow cylindrical housing includes a port for accessing the sealed chamber to service the viscous fluid lubricant.

12. The nozzle assembly according to claim 1, wherein said spray nozzle head includes one or more canted discharge bores fluidly connected to the output end of the tubular shaft.

13. The nozzle assembly according to claim 1, wherein the impeller device includes a plurality of main vanes that extend along the entire length of the impeller body.

14. The nozzle assembly according to claim 13, wherein the impeller device further includes a plurality of secondary vanes that extend along a lower portion of the impeller body.

15. The nozzle assembly according to claim 14, wherein the main and secondary vanes of the impeller device are in line with a central axis of rotation.

16. The nozzle assembly according to claim 14, wherein the main and secondary vanes of the impeller device are curved in reference to the central axis of rotation.

17. The nozzle assembly according to claim 1, wherein the turbine blades are aligned perpendicular to a central axis of rotation.

18. The nozzle assembly according to claim 1, wherein the turbine blades are aligned at an acute angle to a central axis of rotation.

19. The nozzle assembly according to claim 1, wherein the viscous fluid lubricant comprises automatic transmission fluid or silicon-based oils.

20. The nozzle assembly according to claim 1, wherein said means for defining said sealed chamber between said housing body and said tubular shaft structure for enclosing said bearing mechanisms and a viscous fluid lubricant, comprise a rear shaft seal configured near the rear shaft bearing and a front shaft seal on said front cap member.
